(19) United States
(12) Patent Application Publication
(10) Pub. No.: US 2020/0128648 A1
(43) Pub. Date: Apr. 23, 2020

(54) LIGHT EMITTING DEVICES AND METHODS

(71) Applicant: ZIGEN LIGHTING SOLUTION Co., Ltd., Hiroshima (JP)

(72) Inventor: Tomokazu Nada, Hiroshima (JP)

(21) Appl. No.: 16/724,847

(22) Filed: Dec. 23, 2019

Related U.S. Application Data
(63) Continuation of application No. PCT/JP2018/013250, filed on Mar. 29, 2018.

(30) Foreign Application Priority Data
Nov. 13, 2017 (JP) 2017218001
Mar. 15, 2018 (JP) 2018047546

(51) Int. Cl. H05B 45/40; H05B 45/20

(52) U.S. Cl. CPC H05B 45/40; H05B 45/20

(57) ABSTRACT

A light emitting device capable of adjusting light color by means of power input to two sets of electrode terminals, comprising a plurality of light emitting circuits having semiconductor light emitting elements connected in parallel between each of the two sets of electrode terminals. At least one of the light emitting circuits provided between the respective set of the electrode terminals is an individual light emitting circuit through which a current flows by energization between either set of the electrode terminals. At least one of the light emitting circuit is a shared light emitting circuit having a common wiring section through which a current flows by energization between any set of the electrode terminals. An emission color by energization between each set of the electrode terminals is different from each other.

This application claims priority under 35 U.S.C. § 120 to, and is a continuation of, co-pending International Application PCT/JP2018/013250, filed Mar. 29, 2018, which claims priority to Japanese Applications 2017-218001, filed Nov. 13, 2017 and 2018-047546, filed Mar. 15, 2018, such Japanese Applications also being claimed priority to under 35 U.S.C. § 119. These Japanese and International applications are incorporated by reference herein in their entireties.

### BACKGROUND

### Field

The present invention relates to a light emitting device, and more particularly to a light emitting device capable of adjusting light output and emission color by power input from a plurality of electrode terminals.

In recent years, semiconductor light emitting devices such as light emitting diodes (LEDs), organic ELs, inorganic ELs and the like have been developed, and are widely used for applications such as lighting and displays because of high luminous efficiency and long lifetime.

In lighting applications, lighting fixtures have also been developed that adjust brightness and emission color according to time zone or scene, etc., and lighting using semiconductor light emitting devices has become more sophisticated. In particular, with the spread of circadian lighting control that takes biological rhythm into account, the demand for light-emitting devices that change white light from bulb color to daylight color is expected to increase in the future.

A semiconductor light emitting element generally exhibits a substantially constant emission color with respect to input power. Thus, for example, in order to change an emission color of a light emitting device using LEDs, it is necessary to mix light from a plurality of LEDs emitting different emission colors. The same applies to other semiconductor light emitting devices.

For a white light emitting lighting device which has a light emitting circuit emitting bulb color and a light emitting circuit emitting daylight color between two sets of electrode terminals, adjusting an illuminance and color temperature of a lighting apparatus is realized by controlling input power to each light emitting circuit by means of a current amount, PWM(Pulse Width Modulation) or the like. An emission color is generally expressed by such as a chromaticity point with xy coordinates on the CIE 1931chromaticity diagram, and when toning is performed using two types of light emitting circuits of bulb color and a daylight color for example, a chromaticity point indicating the emission color of the light emitting device moves linearly between the chromaticity points indicating the emission color of the respective light emission circuits. In the description of the present invention, chromaticity points are indicated by xy coordinates on the CIE 1931 chromaticity diagram, unless otherwise specified.

CITATION LIST Patent Literature PTL 1: Japanese Patent Publication No. 5320993 PTL 2: Japanese Patent Publication No. 5718461

### SUMMARY

However, a natural change of white color is along a black body radiation locus, and the black body radiation locus draws a gentle upward curve on the xy chromaticity diagram. Thus, when toning is performed with two types of light emitting circuits, even if the emission color of each light emission circuit is on the black body radiation locus, the emission color of the light emitting device becomes unnaturally away from the black body radiation locus at the middle point of the color change. Therefore, for example, as proposed in Patent Document 1 etc., it is known to have a light emission of a light emitting device along the black body radiation locus by adjusting input power of three or more light emission circuits having different emission colors.

However, to realize above, a system control is necessary which receives the settings of brightness and emission color, calculates necessary input power values to three or more light emitting circuits, and sets signals to each power supply source specifying input power values to each light emitting circuit. Thus, it becomes complicated and increases a cost.

In addition, as the number of light emitting circuits increases, a cost increases, and it is complicated to connect three or more sets of electrode terminals between each light emitting circuit and current supply units.

Also, in any method above, each light emitting circuit is energized individually. Thus, in order to obtain a high light output by energizing either of the light emitting circuit which emits a specific emission color, it is necessary to increase the number of light emitting elements on that circuit and to input more power. However, more light emitting elements in the light emitting device increase a cost, and also requires a wider mounting area. Also, when an input power is increased, a current per light emitting element increases and the light emission efficiency decreases.

In particular, for a lighting device capable to adjust a light output and a color temperature in a limited light source area, such as a chip-on-board (COB) type shown in Patent Document 2, the cost per light output increases if the input power is limited. In addition, applicable lighting fixtures may be limited due to insufficient light intensity or the like.

The present invention has been made in view of the above problems, and its object is to provide a light emitting device with a simple configuration which is able to change emission color along the black body radiation locus by a power input to two sets of electrode terminals without requiring a complicated control, and to efficiently increase an allowable input power even if the area of a light source is limited.

### Solution to Problem

In order to achieve the above object, a light emitting device of the present invention is a light emitting device comprising a plurality of light emitting circuits connected in parallel between a first set of electrode terminals and a second set of electrode terminals. Each of the light emitting circuits includes a light emitting portion having a semiconductor light emitting element. At least one of the light emitting circuits between the respective set of the electrode terminals is an individual light emitting circuit through which a current flows by energization between either set of the electrode terminals. At least one of the light emitting circuits between the respective set of the electrode terminals is a shared light emitting circuit having a common wiring through which a current flows by energization between any set of the electrode terminals, and an emission color by energization between the first set of electrode terminals and an emission color by energization between the second set of electrode terminals are different from each other.

In the light emitting device of the present invention, the individual light emitting circuit is a light emitting circuit that emits light when a current flows by energization between either set of the electrode terminals, and does not emit light or emits restricted light when energization between another set of the electrode terminals. In the light emitting device of the present invention, the shared light emitting circuit consists from a common wiring section and a dedicated wiring section that electrically connects the common wiring section and each electrode terminal.

Provided with the common wiring section, the ratio of the current flowing through the individual light emitting circuit and the shared light emitting circuit in each set of the electrode terminals changes according to the current balance between the two sets of the electrode terminals, and thereby the light output and color is adjusted. Further, the light emitting portion in the common wiring section efficiently increases the allowable input power even with a small number of light emitting elements.

In one aspect of the light emitting device of the present invention, the emission color of the individual light emitting circuit and the emission color of the shared light emitting circuit are different in each set of the electrode terminals. In one aspect of the light emitting device according to the present invention, the chromaticity point of the emission color of the individual light emission circuit exists in a positive region, the chromaticity point of the emission color of the shared light emitting circuit exists in a negative region, with respect to a straight line connecting the chromaticity point of the emission color of the light emitting device by energization only between the first set of electrode terminals and the chromaticity point of the emission color of the light emitting device by energization only between the second set of electrode terminals.

In one aspect of the light emitting device of the present invention, the chromaticity point of the emission color of the individual light emission circuit exists in a positive region with respect to the black body radiation locus, and the chromaticity point of the emission color of the shared light emission circuit exists in a negative region with respect to the black body radiation locus.

By setting the emission color of each light emission circuit to an appropriate chromaticity point, the color change of the light emission device is able to draw an upward curve on the xy chromaticity diagram, and further along the black body radiation locus.

In one aspect of the light emitting device according to the present invention, a shunt is connected to the first set of electrode terminals and the second set of electrode terminals, and the shunt splits the input current from a single power source. In the light emitting device of the present invention, the semiconductor light emitting element is, for example, a light emitting diode (LED), an organic EL, an inorganic EL or the like. Various types of LED elements may be used that emits unique colors such as InGaN-based blue LEDs and GaAlAs-based red LEDs. In general, semiconductor light emitting elements are packaged and used.

### Advantageous Effects of Invention

According to the present invention, it is possible to provide a light emitting device with a simple configuration which is able to change emission color along the black body radiation locus by a power input to two sets of electrode terminals without requiring a complicated control, and to efficiently increase an allowable input power even if the area of a light source is limited.

### BRIEF DESCRIPTION OF DRAWINGS

FIG. 1 is a wiring diagram of a light emitting device according to Embodiment 1 of the present invention.

FIG. 2 is a graph which shows chromaticity coordinates according to Embodiment 1 of the present invention.

FIG. 3 is a graph which shows chromaticity coordinates according to Embodiment 1 of the present invention.

FIG. 4 is a wiring diagram of a light emitting device according to Embodiment 2 of the present invention.

FIG. 5 is a graph which shows chromaticity coordinates according to Embodiment 2 of the present invention.

FIG. 6 is a wiring diagram of a light emitting device according to Embodiment 3 of the present invention.

FIG. 7 is an outline drawing of a light emitting device according to Embodiment 3 of the present invention.

FIG. 8 is a wiring diagram of a light emitting device according to Embodiment 4 of the present invention.

FIG. 9 is a graph which shows chromaticity coordinates according to Example of the present invention.

### DETAILED DESCRIPTION

Hereinafter, a light emitting device of the present invention will be described with reference to the accompanying drawings. In the drawings of the present invention, the same reference numerals are used to represent the same or corresponding parts. Also, in the following description, the same names and reference numerals, in principle, indicate the same or equivalent members, and a detailed description will be appropriately omitted. In addition, dimensional relationships such as length, width, thickness and depth are appropriately changed for clarification and simplification of the drawings, and do not represent actual dimensional relationships.

### Embodiment 1

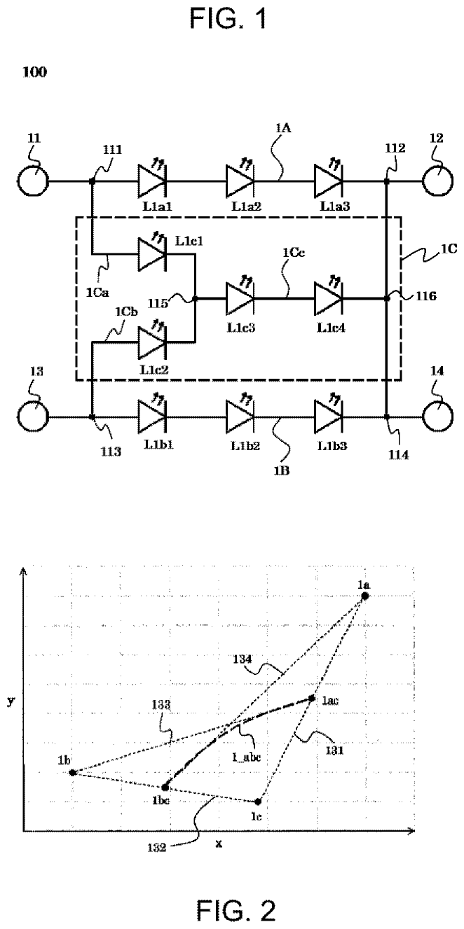

As shown in FIG. 1, a light emitting device 100 according to the first embodiment of the present invention has anode electrode terminals 11 and 13 and cathode electrode terminals 12 and 14. The electrode terminals 11 and 12 are one set, and the electrode terminals 13 and 14 are another set. Light is emitted as current flows through each set of electrode terminals. In the embodiment shown in FIG. 1, the cathode electrode terminals 12 and 14 may be common.

Wirings 1A and 1C are connected in parallel between the electrode terminals 11 and 12, and wirings 1B and 1C are connected in parallel between the electrode terminals 13 and 14. LED packages L1a 1, L1a 2 and L1a 3 are arranged in series between connection points 111 and 112 on the wiring 1A, LED packages L1b 1, L1b 2 and L1b 3 are arranged in series between connection points 113 and 114 on the wiring 1B. On the wiring 1C, a LED package L1c1 is arranged between connection points 111 and 115, a LED package L1c 2 is arranged between the connection points 113 and 115, and LED packages L1c 3 and L1c 4 are arranged in series between connection points 115 and 116. It is preferable that the number of series connection of the LED packages on each wiring is appropriately adjusted according to a desired light output, a specification of an input power supply apparatus, and the like.

The wiring 1C can be divided into a dedicated wiring section 1Ca between the connection points 111 and 115 where a current flows when energization between the electrode terminals 11, 12 and a dedicated wiring section 1Cb between the connection points 113 and 115 where a current flows when energization between the electrode terminals 13, 14, and a common wiring section 1Cc between the connection points 115 and 116 where a current always flows by energization between any set of the electrode terminals.

The dedicated wiring sections 1Ca and 1Cb may be arranged on the anode side, the cathode side, or both sides.

The wirings 1A and 1B are individual light emitting circuits that emit light by energization between either set of the electrode terminals, and the wiring 1C is a shared light emitting circuit that emits light by energization between any set of the electrode terminals. The current between the electrode terminals 11, 12 flows through the wiring 1A and 1C, and the current between the electrode terminals 13, 14 flows through the wiring 1B and 1C.

A wiring may be further formed for the purpose of protecting the LED packages, and a current may flow to the individual light emitting circuit or a part thereof when energization between different electrode terminals from those originally connected. In this case, it is preferable that the amount of the current and the light output is limited by connection of high-resistance components, etc., so that there is no influence on the current flow to the individual light emitting circuit when energization between the originally connected electrode terminals, and the emission color change of the light emitting device is not affected.

The light emitting device 100 emits light of the emission color of the LED packages arranged on the wirings 1A and 1C when energization only between the electrode terminals 11, 12, and emits light of the emission color of the LED packages arranged on the wirings 1B and 1C when energization only between the electrode terminals 13, 14, and emits light of the emission color of the LED packages arranged on the wirings 1A, 1B and 1C when energization between both the electrode terminals 11, 12 and 13, 14. Thus, the light output and color change of the light emitting device 100 can be realized by appropriately selecting the emission color of the LED packages on each wiring and adjusting the current amount and current balance between the electrode terminals 11, 12, and 13, 14.

As the LED packages are disposed on the wirings 1A and 1C between the electrode terminals 11 and 12, the wirings have diode characteristics. Preferably, the threshold voltages at which current starts to flow through each wiring are substantially the same. Thereby, the current ratio between the wirings 1A and 1C can be approximately constant over a wide current range, and stable emission color can be obtained even at different currents, when the light emitting device 100 is energized only between the electrode terminals 11 and 12. Note that the threshold voltages of the wirings 1A and 1C are obtained as the sum of the threshold voltages of the LED packages connected in series.

Preferably, LED elements are of the same type, connected by the same number of series on each of the wirings 1A and 1C, so that the threshold voltages of the wirings are substantially same and kept close to each other against temperature changes. Also, when different types of LED elements are used on the same wiring, it is preferable that each type of LED elements is arranged by the same number of series on the wirings 1A and 1C.

In the light emitting device 100, it is preferable that each wiring is constituted only by LED packages, because there is no power consumption by electronic components that does not contribute to light emission and the efficiency of the light emitting device can be improved.

An LED package may be connected between the electrode terminal and the branch point of the wiring. For example, by connecting an LED package between the electrode terminal 11 and the connection point 111, the light output or the emission color of the light emitting device can be adjusted.

An electronic component other than an LED package may be connected on wiring in order to adjust light output, emission color, etc. It is preferable to connect the same electric components on the wiring 1A and 1C by the same number so that the threshold voltages are maintained close to each other. For example, Lid may be a diode, but it is preferable that the same diode replaces one LED package on the wiring 1A.

An LED package may not be mounted on the dedicated wiring section 1Ca or the common wiring section 1Cc in the wiring 1C, and the light output and emission color of the light emitting device 100 can be adjusted as necessary. In order to prevent the current between the electrode terminals 13 and 14 from flowing through the wiring 1A which is an individual light emitting circuit, the threshold voltage of the common wiring section 1Cc is preferably lower than the threshold voltage of the wiring 1A, and an electric component having diode characteristics is preferably connected on the dedicated wiring section 1Ca. Further, when an LED package is not connected on the common wiring section 1Cc, it is preferable that some electronic component including a resistor be connected, thus the current division ratio to each wiring can be adjusted depending on the magnitude of the voltage applied to the common wiring section 1Cc.

With regard to a resistor, the influence on the threshold voltage is small, and resistors of different resistance may be connected on each wiring for adjusting such as division ratio to each wiring.

The threshold voltages of the wiring 1A and 1C between the electrode terminals 11 and 12 may be set different from each other so that the aspect of toning of the light emitting device 100 may be different in the low current region and the high current region.

The above-mentioned contents are the same for the wiring 1B and 1C between the electrode terminals 13 and 14.

Provided with the wiring 1C which is a shared light emitting circuit, the allowable current amount through the light emitting device 100 can be efficiently increased with a limited number of wirings, because a current always flows through the wiring 1C by energization between any set of the electrode terminals.

Further, each of the wirings 1A, 1B, and 1C may be configured by multiple wirings connected in parallel, and the allowable current amount and the light emission aspect can be adjusted.

The number of series connected LED elements and the threshold voltage may be different between the electrode terminals 11 and 12 and between the electrode terminals 13 and 14. In this case, it is preferable that the number of LED packages in series and the like of the dedicated wiring sections 1Ca and 1Cb be adjusted so that the threshold voltages of the wirings connected in parallel in each set of the electrode terminals become substantially the same.

In order to realize the emission color change of the light emitting device 100, the emission color of the light emitting device 100 by the light emission from the wirings 1A and 1C when energization only between the electrode terminals 11 and 12, and the emission color of the light emitting device 100 by the light emission from the wirings 1B and 1C when energization only between the electrode terminals 13 and 14, are preferably different.

Preferably, the emission colors of the wirings 1A and 1B are different from each other, and further preferably, the emission colors of the wirings 1A, 1B and 1C are different from each other, so that a more desirable emission color change of the light emitting device 100 can be obtained.

In this description, the emission color of each wiring means the emission color of the LED package group of each wiring by the emission from the LED packages on each wiring when energization. LED packages having different emission colors may be used on the same wiring. Alternatively, different regions may be provided on the same wiring, and the emission color is different for each region to achieve a special effect. In the following description, for the sake of simplicity, unless otherwise specified, the emission color of each wiring is described assuming that light from the LED packages on the wiring are mixed to emit one emission color.

In the light emitting device 100, when a current is supplied to both sets of the electrode terminals between 11 and 12 and between 13 and 14, the amount of the current flowing to each of wiring 1A, 1B and 1C is determined by the voltage applied to the common wiring section 1Cc in the wiring 1C.

In order to explain in more detail, each voltage has the following relation. The voltage of the wiring 1A (between the connection points 111 and 112) is described as Va, the voltage of the wiring 1B (between the connection points 113 and 114) is described as Vb, the voltage of the dedicated wiring section 1Ca (between the connection points 111 and 115) is described as Vca, the voltage of dedicated wiring section 1Cb (between the connection points 113 and 115) is described as Vcb, and the voltage of the common wiring section 1Cc (between the connection points 115 and 116) is described as Vc.

Va=Vca+Vc

Vb=Vcb+Vc

The voltage Vc applied to the common wiring section 1Cc needs to be a voltage for causing the sum of the currents flowing through the dedicated wiring sections 1Ca and 1Cb to flow, thus a current flowing ratio to each wiring is adjusted when energization from both sets of electrode terminals. For example, when the current flowing between the electrode terminals 11 and 12 is large, Va, Vca and Vc increase. At this time, if a relatively small current flows between the electrode terminals 13 and 14, Vcb is small by the relationship of Vcb=Vb−Vc because of high Vc. Thus, the current is hard to flow to the dedicated wiring section 1Cb, and accordingly, the current between the electrode terminals 13 and 14 flows through the wiring 1B.

In particular, if Vcb does not reach the threshold voltage of the LED package L1c 2, the current between the electrode terminals 13 and 14 cannot flow to the wiring 1C through the dedicated wiring section 1Cb. Thus, the current flowing through the common wiring section 1Cc in the wiring 1C comes from between the electrode terminals 11 and 12, and the current between the electrode terminals 13 and 14 just flows through the wiring 1B.

When Vcb exceeds the threshold voltage of the LED package L1c 2 due to, for example, an increase in a current between the electrode terminals 13 and 14, a current flow to the common wiring section 1Cc in the wiring 1C via the dedicated wiring section 1Cb.

When the current balance between the electrode terminals further changes and the current flowing to the common wiring section 1Cc through the dedicated wiring section 1Cb from between the electrode terminals 13 and 14 increases, Vc becomes more than necessary value for causing the current from the dedicated wiring section 1Cb to flow. Thus, from the relation of Vca=Va−Vc, a current gets hard to flow through the dedicated wiring section 1Ca in the same manner as described above. Further, when Vca falls below the threshold voltage of the LED package Lid, the current between the electrode terminals 11 and 12 cannot flow to the wiring 1C through the dedicated wiring section 1Ca. Thus, the current flowing through the common wiring section 1Cc in the wiring 1C comes from between the electrode terminals 13 and 14, and the current between the electrode terminals 11 and 12 just flows through the wiring 1A.

When a current through the wiring 1C is from both sets of electrode terminals, the voltages Vca and Vcb of the dedicated wiring sections 1Ca and 1Cb decrease because a current is divided to the dedicated wiring sections 1Ca and 1Cb. And accordingly, the voltage applied to the common wiring section 1Cc increases. Thus, the current through the common wiring section 1Cc is larger compared to the current through the wirings 1A and 1B.

The emission color of the light emitting device 100 exhibits the following change with respect to above mentioned changes of the current flowing to each wiring.

The emission color change of the light emitting device 100 will be described with reference to FIG. 2 with chromaticity points indicating emission colors of the wirings 1A, 1B and 1C on the xy chromaticity diagram as 1a, 1b and 1c, respectively. For the sake of simplicity in explanation, LED packages L1c1 and L1c 2 are set to the same emission color. Thereby, even if current flows to either of the dedicated wiring sections 1Ca and 1Cb, the chromaticity point 1c of the emission color of wiring 1C does not change.

In the case of energizing only between the electrode terminals 11 and 12, a chromaticity point of the emission color of the light emitting device 100 is located at 1ac according to the intensity ratio of the light output from the wiring 1A and 1C, on the straight line 131 connecting between the chromaticity points 1a and 1c. Similarly, in the case of energization only between the electrode terminals 13 and 14, a chromaticity point of the emission color of the light emitting device 100 is located at 1bc according to the intensity ratio of the light output from the wiring 1B and 1C, on the straight line 132 connecting between the chromaticity points 1b and 1c.

When energization between both sets of the electrode terminals 11, 12 and 13, 14, if the current between the electrode terminals 11, 12 is sufficiently larger than the current between the electrode terminals 13, 14, the current from the dedicated wiring section 1Ca becomes dominant in the wiring 1C, and the current between the electrode terminals 13 and 14 flows almost only through the wiring 1B. Thereby, the chromaticity point of the emission color of the light emitting device 100 is located at close to the chromaticity point 1ac, on the straight line connecting between the chromaticity points 1ac and 1b.

When the current between the electrode terminals 13 and 14 increases with respect to the current between the electrode terminals 11 and 12, and the current flows to the wiring 1C through the dedicated wiring section 1Cb, the current ratio flowing through 1A increases among the current between the electrode terminals 11 and 12, and the current ratio flowing through 1B decreases among the current between the electrode terminals 13 and 14. Thus, a chromaticity point of the emission color of the light emitting device 100 is located on the straight line connecting between the chromaticity points between the chromaticity points 1ac, 1a and the chromaticity point between the chromaticity points 1bc, 1b, and moves by the change in the light emission intensity from each wiring according to the change in the current ratio between sets of the electrode terminals.

When the current from both sets of the electrode terminals flows to the wiring 1C, as described above, the current flowing through the common wiring section 1Cc is larger than the current flowing through the wirings 1A and 1B. Thus, the chromaticity point of the emission color of the light emitting device 100 does not pass through the intersection of straight lines 133 and 134 but passes a little shifted point toward the chromaticity point 1c.

When the current between the electrode terminals 13 and 14 is further increased with respect to the current between the electrode terminals 11 and 12, the current from the dedicated wiring section 1Cb becomes dominant in the wiring 1C, and the current between the electrode terminals 11 and 12 flows almost only through the wiring 1A. Thereby, the chromaticity point of the emission color of the light emitting device 100 is located at close to the chromaticity point 1bc, on the straight line connecting between the chromaticity points 1a and 1bc.

From the above, the emission color of the light emitting device 100 changes so as to draw a gentle curve 1_abc on the xy chromaticity diagram.

In particular, as shown in FIG. 2, with respect to a straight line connecting the emission color 1ac of the light emitting device 100 when energization only between the electrode terminals 11 and 12 and the emission color 1 bc of the light emitting device 100 when energization only between the electrode terminals 13 and 14, if the chromaticity points 1a and 1b of the emission colors of the wirings 1A and 1B are located in the positive region and the chromaticity point 1c of the emission color of the wiring 1C is located in the negative region, the emission color change of the light emitting device 100 shows an upward curve on the xy chromaticity diagram.

Further, by placing the chromaticity point 1c of the emission color of the wiring 1C in a negative region and the chromaticity points 1a and 1b of the emission color of the wirings 1A and 1B in a positive region with respect to the black body radiation locus, and by setting each of the light output and the chromaticity point appropriately, the emission color change of the light emitting device 100 following the black body radiation locus can be realized.

Preferably, one of the chromaticity points 1ac and 1bc is a color point of a color temperature lower than 3000K, and the other is a color point of a color temperature higher than 4000K, realizing a color change from bulb color to white.

If the light output from the wirings 1A and 1B is set larger than the light output from the wiring 1C by adjusting parallel number of each wiring or by selecting light output rank of the LED package, the chromaticity points 1ac, 1bc get close to the chromaticity points 1a, 1b respectively, and the color range of the light emitting device 100 can be made wider.

Similarly, if the emission colors of the LED packages L1c1 and L1c 2 on the dedicated wiring sections 1Ca and 1Cb are the same as or similar to the emission colors of the wirings 1A and 1B connected in parallel, the chromaticity points 1ac, 1bc get close to the chromaticity points 1a, 1b respectively, and the color range of the light emitting device 100 can be made wider also.

By arranging the chromaticity points of the emission colors of the wirings 1A, 1B, and 1C apart from each other, the spectra of the different emission colors overlap, so that high-quality light with high color reproducibility can be obtained.

When a current from a single power source is divided and applied to both sets of the electrode terminals 11, 12 and 13, 14, if the threshold voltages between the electrode terminals are substantially the same as shown in the present embodiment, the currents flowing through the wirings 1A, 1B and 1C get substantially equal, and the light emitting device 100 emits mixed light of the emission colors from each wiring weighted by the light output.

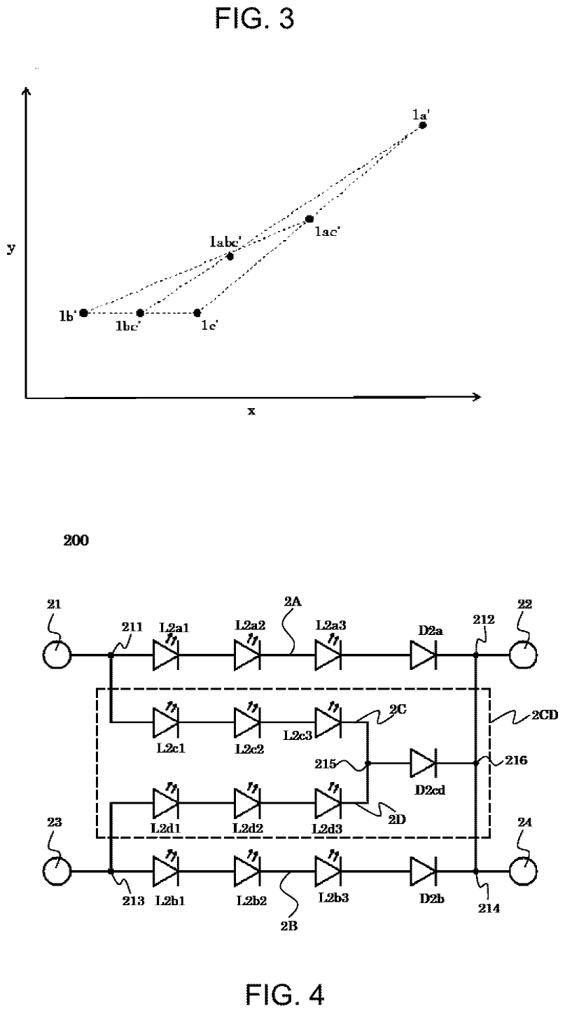

For example, as shown in FIG. 3, when the chromaticity point 1c′ of the emission color of the wiring 1C is closer to the chromaticity point of either one of the individual light emitting circuits, the chromaticity point 1abc′ obtained when the input current is shunted to both sets of the electrode terminals is different from the midpoint of the chromaticity points 1ac′ and 1bc′ obtained by energization between either set of the electrode terminals.

It is also possible to further adjust the emission color of the light emitting device 100 when operated with the shunted input current, by selecting the emission color of the LED packages on the dedicated wiring sections 1Ca and 1Cb, or adjusting parallel number of wirings of a particular emission color. The emission color of the wiring 1C, which is the shared light emitting circuit, may be same as the emission color of either of the individual light emitting circuits.

For a light emitting device consisting of only two individual light emitting circuits, the chromaticity point of the light emitting device locates at a midpoint weighted to the light emission intensities of the two emission colors, when operated by shunted input current from a single power source. On the other hand, in the present invention, it is possible to set a chromaticity point more arbitrarily even when operated by shunted input current. For example, the emission color of the color temperature of 2700 K, 3000 K and 4000 K, which is often used as the emission color of lighting, may be obtained as chromaticity points on black body radiation curve, respectively, simply by switching energization between either set of the electrode terminals or both set of the electrode terminals using a shunt.

It is preferred a shunt simply switches energization between each set of the electrode terminals and energization between both sets of the electrode terminals, such that a shunt can be configured by a small number of parts using mechanical switches, electrical switching elements, etc and easy for operation. Alternatively, the ratio of the diversion may be adjusted using resistance or the like, or a plurality of diversion ratios may be set by necessity.

### LED Package

The LED packages L1a 1 to L1c 4 are electronic components on which LED elements are mounted and emit light from the LED elements through translucent resin or the like. The light from the LED element may be emitted as it is or may be converted by a phosphor. Moreover, a chip scale package type, a surface mounting type, a chip on board (COB) type, etc. may be selected. When used for lighting, generally, a white LED package is used, in which part or all of the light from an InGaN-based LED element is converted by a phosphor to emit white light, and an emission color is appropriately selected.

Since current-voltage characteristics such as threshold voltage affect the color change characteristics of the light emitting device, LED packages are preferably sorted by electrical characteristics and used.

In order to obtain uniform light as a light emitting device, each LED package is preferably placed at a close distance for easy color mix, or LED packages of different emission colors adjacent are equally spaced to each other.

For example, in a strip light where LED packages are mounted on a flexible substrate or the like, light from LED packages can be easily mixed by alternately arranging the LED packages of the wirings 1A, 1B and 1C.

Alternatively, LED packages may be placed at a position where the light does not mix for a special lighting effect like the light direction from the light emitting device changes depending on emission color or the like.

Further, by providing three or more sets of the electrode terminals each equipped with an individual light emitting circuit and a shared light emitting circuit in parallel, the color change of the light emitting device can be more finely controlled. Note that the shared light emitting circuit may be arranged such that current flows from two sets of electrode terminals, or from three or more sets of electrode terminals.

### Embodiment 2

As shown in FIG. 4, the light emitting device 200 according to the second embodiment of the present invention has anode electrode terminals 21 and 23 and cathode electrode terminals 22 and 24. The electrode terminals 21 and 22 are one set and connect with the wirings 2A and 2C arranged in parallel. The electrode terminals 23 and 24 are another set and connect with the wirings 2B and 2D arranged in parallel. In the embodiment shown in FIG. 4, the cathode electrode terminals 22 and 24 may be common.

LED packages L2a 1, L2a 2, L2a 3 and diode D2a are arranged in series between connection points 211-212 on the wiring 2A. LED packages L2b 1, L2b 2, L2b 3 and diode D2b are arranged in series between connection points 213-214 on the wiring 2B. LED packages L2c 1, L2c 2, L2c 3 are arranged in series between the connection points 211-215 on the wiring 2C, LED packages L2d 1, L2d 2, L2d 3 are arranged in series between the connection points 213-215 on the wiring 2D, and a diode D2cd is arranged on a common wiring between connection points 215-216. It is preferable that the series and parallel number of LED packages and diodes on the respective wirings appropriately adjusted according to a desired light output, a specification of an input power supply apparatus, and the like.

It is preferable that the wiring 2A and the wiring 2C including the common wiring section are configured by the same type of LED elements connected by the same number of series and the same type of diodes connected by the same number of series. Thus, the threshold voltages of the respective wirings can be made substantially the same and a stable emission color can be obtained even at different current when energization between the electrode terminals 21 and 22. The same applies to the wirings 2B and 2D.

In the present embodiment, the wirings 2A and 2B are individual light emitting circuits, and the wirings 2C and 2D including the common wiring section provided with the diode D2cd form a shared light emitting circuit 2CD. The current between the electrode terminals 21 and 22 flows through the wirings 2A and 2C, and the current between the electrode terminals 23 and 24 flows through the wirings 2B and 2D.

In the light emitting device 200, when energization only between the electrode terminals 21 and 22, a mixed color of the light emission from the wirings 2A and 2C is emitted. When energization only between the electrode terminals 23 and 24, a mixed color of the light emission from the wirings 2B and 2D is emitted. And when energization between both sets of the electrode terminals 21, 22 and 23, 24, a mixed color of the light emission from the wirings 2A, 2B, 2C and 2D is emitted. Thus, by appropriately selecting the emission color of the LED packages on the respective wirings and adjusting the current amount and current balance between sets of the electrode terminals 21, 22 and 23, 24, the light output and emission color of the light emitting device 200 can be adjusted.

When a current is supplied to both sets of the electrode terminals 21, 22 and 23, 24, the current flowing through the wirings 2C and 2D both flows to the diode D2cd. As described in the first embodiment, due to a driving voltage necessary for flowing the current to the diode D2cd, the current division ratio to each wiring in each set of electrode terminals varies depending on the current balance between the electrode terminals.

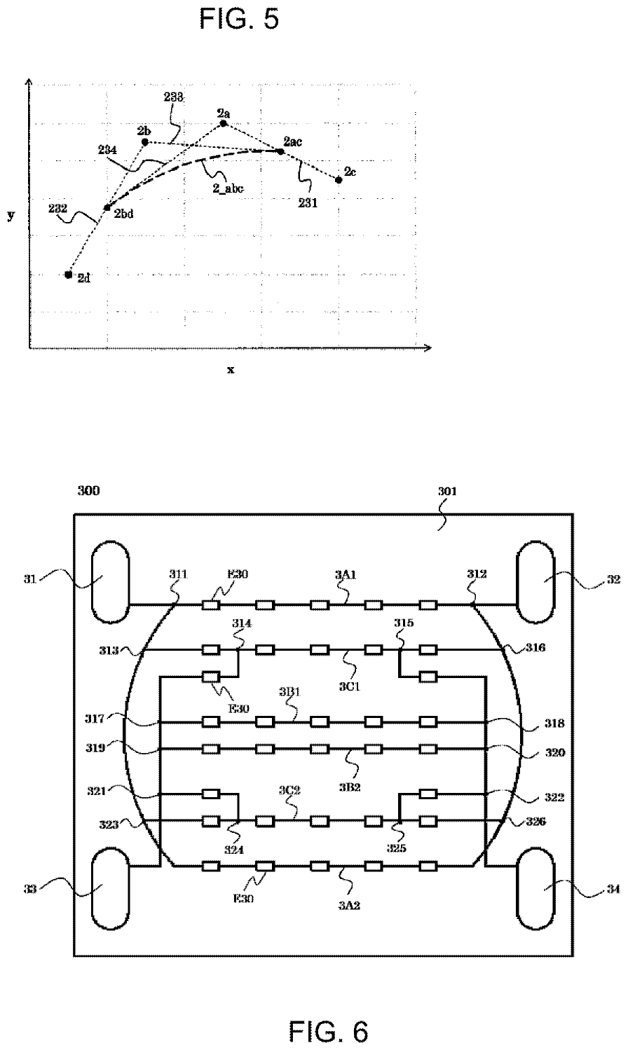

The change in emission color of the light emitting device 200 with respect to the change of the current balance between the electrode terminals will be described with reference to FIG. 5. Note that chromaticity points indicating emission colors of the wirings 2A, 2B, 2C, and 2D in the xy chromaticity diagram are respectively 2a, 2b, 2c, and 2d.

As in the first embodiment, in the case of energization only between the electrode terminals 21 and 22, the chromaticity point of the emission color of the light emitting device 200 is 2ac on the straight line 231 connecting the chromaticity points 2a and 2c according to the intensity ratio of the light output from the wirings 2A, 2C. Similarly, in the case of energization only between the electrode terminals 23 and 24, the chromaticity point of the emission color of the light emitting device 200 is 2bd on the straight line 232 connecting the chromaticity points 2b and 2d according to the intensity ratio of the light output from the wirings 2B, 2D.

When the current between the electrode terminals 21 and 22 is sufficiently larger than the current between the electrode terminals 23 and 24 and the current from the wiring 2C is dominant among the currents flowing to the diode D2cd, the chromaticity point of the emission color of the light emitting device 200 is located at close to the chromaticity point 2ac, on the straight line 233 connecting between the chromaticity points 2ac and 2b.

When the current ratio between the electrode terminals 23 and 24 increases with respect to the current between the electrode terminals 21 and 22 to cause the current flowing through the wiring 2D, the current ratio flowing through 2A increases among the current between the electrode terminals 21 and 22, and the ratio flowing through 1B decreases among the current between the electrode terminals 23 and 24. Thus, a chromaticity point of the emission color of the light emitting device 200 is located on the straight line connecting between the chromaticity point between the chromaticity points 2ac, 2a and the chromaticity point between the chromaticity points 2bc, 2b, and moves by the change of light emission intensity from each wiring according to the change of the current ratio between the electrode terminals.

When the current between the electrode terminals 23 and 24 is further increased, the current from the wiring 2D becomes dominant in the current flowing through the diode D2cd, and the current between the electrode terminals 21 and 22 almost flows only through the wire 2A. Accordingly, the chromaticity point of the emission color of the light emitting device 200 is located at close to the chromaticity point 2bd, on the straight line 234 connecting between the chromaticity points 2bd and 2a.

From the above, the emission color of the light emitting device 200 changes so as to draw a gentle curve 2_abc on the xy chromaticity diagram.

In particular, as shown in FIG. 5, with respect to a straight line connecting the emission color 2ac of the light emitting device 200 by energization only between the electrode terminals 21 and 22 and the emission color 2bd of the light emitting device 200 by energization only between the electrode terminals 23 and 24, if the chromaticity points 2a and 2b of the emission color of the wirings 2A and 2B are located in the positive region and the chromaticity points 2c and 2d of the emission color of the wirings 2C and 2D are located in the negative region, the emission color change of the light emitting device shows an upward curve on the xy chromaticity diagram.

Further, by placing the chromaticity points 2a and 2b of the emission colors of the wirings 2A and 2B in a positive region and the chromaticity points 2c and 2d of the emission colors 2C and 2D in a negative region with respect to the black body radiation locus, and by setting each of the light output and the chromaticity point appropriately, the emission color of the light emitting device 200 is able to change following the black body radiation locus.

Preferably, one of the chromaticity points 2ac and 2bd is a color point of a color temperature lower than 3000K, and the other is a color point of a color temperature higher than 4000K, realizing a color change from bulb color to white.

Each of the diodes D2a, D2b, and D2cd may be a light emitting element such as an LED, and the light emission efficiency of the light emitting device can be increased. Alternatively, it may be another electronic component whose voltage value varies according to the magnitude of the current.

Each diode may be a resistor, and it becomes a current limiting resistor and can cope with a constant voltage input. The resistance value of each wiring may be different in order to adjust the current to each wiring.

In the case of constant voltage input, the input power to each electrode terminal can be easily adjusted by PWM control or the like. Particularly, by synchronizing the pulse power input to each electrode terminal, the amount of a current flowing through the shared light emitting circuit is controlled, and the color change as described above is obtained.

A constant voltage input, for example, makes it possible to realize a lighting system in which a plurality of light emitting devices of the present invention are connected in parallel to a constant voltage power supply line and the plurality of light emitting devices change color synchronously.

### Embodiment 3

As shown in FIG. 6, a light emitting device 300 according to the third embodiment of the present invention has electrode terminals 31, 32, 33, 34 and a wiring pattern on a substrate 301, and the light emitting circuits 3A1, 3A2, 3B1, 3B2, 3C1, 3C2 in which a plurality of LED elements E30 are connected by gold wire or the like are formed. The series-parallel number of the LED elements E30 on each light emitting circuit is preferably adjusted appropriately according to the desired light output, the specifications of the input power supply apparatus, and the like.

The light emitting circuits 3A1 and 3A2 are formed between the electrode terminals 31 and 32, and the light emitting circuits 3B1 and 3B2 are formed between the electrode terminals 33 and 34 to form individual light emitting circuits for the respective electrode terminals. The light emitting circuits 3C1 and 3C2 are shared light emitting circuits in which current flows by energization between any set of the electrode terminals. The wirings between the connection points 313-314, 317-314, 321-324, 323-324, 315-316, 315-318, 325-322, 325-326, are dedicated wiring sections through which current flows when either set of the electrode terminals is energized, and the wirings between the connection points 314-315 and 324-325 are common wiring sections.

It is preferable that the dedicated wiring section is formed on both the cathode side and the anode side, the circuit configuration can be symmetric, and a symmetrical light emission pattern can be obtained from the light emitting device 300.

With the above configuration, the light emitting circuits 3A1, 3A2, 3C1 and 3C2 emit light when energization between the electrode terminals 31, 32, and the light emitting circuits 3B1, 3B2, 3C1 and 3C2 emit light when energization between the electrode terminals 33, 34.

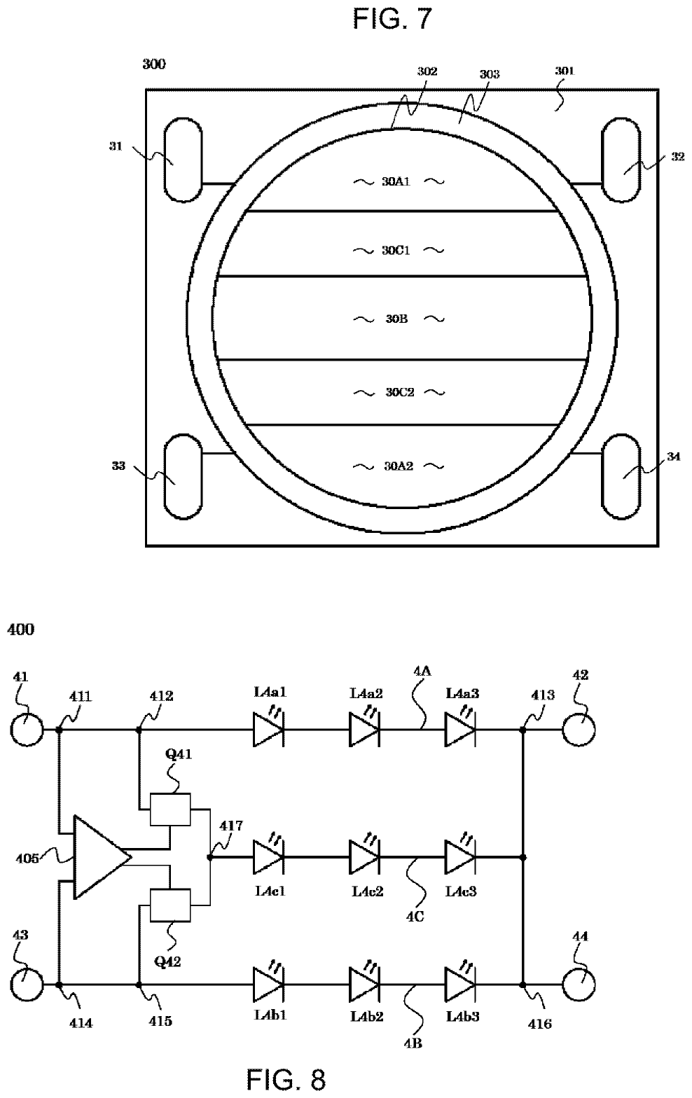

The LED elements E30 on the light emission circuit between the electrode terminals are the preferably same type and are connected by the same number of series, and more preferably, the LED elements sorted by the voltage are used. Thus, the threshold voltages of the light emitting circuits 3A1, 3A2, 3C1 and 3C2 connected in parallel between the terminals 31 and 32 become substantially same, and the same applies to the light emitting circuits 3B1, 3B2, 3C1 and 3C2 connected in parallel between the electrode terminals 33 and 34. And a stable emission color can be obtained over a wide current range when energization between respective electrode terminals. As shown in FIG. 7, the LED elements E30 on each light emitting circuit 3A1, 3A2, 3B1, 3B2, 3C1, 3C2 is covered with a translucent resin in the light emitting portion 302 surrounded by the resin dam 303, and constitute light emitting areas 30A1, 30A2, 30B, 30C1, 30C2.

For white color emission, InGaN-based LED elements having a peak emission wavelength in the violet or blue region are used, and the LED elements are covered with a translucent resin mixed with a phosphor. A part of the primary light emitted from the LED element is converted by the phosphor into light having spectrum in the visible light range, and white light is obtained. It is preferable that the blending ratio of the phosphors be adjusted so that the desired emission color can be obtained from each of the light emitting portions 30A1, 30A2, 30B, 30C1, and 30C2.

In order for the light emitting device 300 to change color, it is preferable that the emission colors between the light emitting areas 30A1, 30A2 and the light emitting area 30B, covering the individual light emitting circuits between the respective electrode terminals are different. More preferably, the light emitting area 30C1 and 30C2 also have different emission colors, allowing a desired emission color change.

In addition, it is preferable that the mixing ratio of the phosphors be adjusted so that the light emitting regions 30A1 and 30A2 emit the same emission color, and a symmetrical light emitting pattern can be obtained from the light emitting portion 302. The same applies to the light emitting areas 30C1 and 30C2.

The translucent resin constituting the light emitting regions 30A1, 30A2, 30B, 30C1 and 30C2 is not limited as long as it has translucency. For example, a silicone resin etc. excellent in heat resistance is preferable. Further, it is preferable that the high thixotropy-type light transmissive resin and the low thixotropy-type light transmissive resin be used so as to be adjacent to each other, and it becomes easy to form each light emitting area.

The resin dam 303 is a resin that blocks the translucent resin covering the light emitting portion 302 and is preferably made of a transparent or white material that hardly absorbs light.

For example, as shown in FIGS. 6 and 7, the light emitting circuits and the light emitting areas are preferably formed symmetrically with respect to the center of the light emitting portion 302. Thereby, a symmetric light emission pattern is obtained from the light emitting portion 302, and light from each light emitting area can be easily mixed.

With the above configuration, the emission color of the light emitting device 300 can change so as to draw a curve on the xy chromaticity diagram by adjusting the current between the electrode terminals in the same manner as described in the first embodiment. And it is also able to realize a color change following the black body radiation locus.

The light emitting device 300 may be constituted in the same manner as described in embodiment 2 for the circuit configuration, the connection of the LED elements, the arrangement of the light emitting region, and the like.

A part of the LED elements of the light emitting circuit may be disposed in a different light emitting area from other LED elements on the same light emitting circuit. Thereby, arrangement of the LED elements in the light emitting portion of the light emitting device 300 can be optimized, and the balance of the light output from each light emitting area can be adjusted. Also, the shared light-emitting circuit and the individual light-emitting circuits may have the same emission color covered with a resin having the same phosphor composition, which facilitates the manufacture of the light-emitting device. Furthermore, even if a resin of same phosphor composition is used, the resin thickness may be partially changed by such as using high thixotropy type resin so as to obtain a desired emission color for each light emitting area.

### Substrate

The substrate 301 on which LED elements are mounted is preferably a material having high reflectance and high heat dissipation, and alumina ceramic, aluminum, or the like is used, and a wiring pattern for mounting of components such as LED element and electrical connection are formed. A so-called chip-on-board type in which all circuits including light emitting portion are provided on a single substrate is preferable because it is easy to handle.

### LED Element

The LED element E30 has an anode electrode pad and a cathode electrode pad, and the LED elements are connected to each other through wires or bumps and a wiring pattern on a substrate. In order to facilitate adjustment of the threshold voltage of each circuit, it is preferable to use LED elements sorted by voltage, for example, every 0.1 V rank.

The same type of LED element is preferably used in the light emitting device 300 for productivity and adjustment of the threshold voltage between parallel circuits.

Since the light emitting device 300 has the wirings 3C1 and 3C2 of the shared light emitting circuits, the LED elements can be used more effectively than when all the light emitting devices 300 are configured as individual light emitting circuits. Thereby, it is possible to drive with a higher input power density and to obtain a higher light emission density from the light emitting unit 302.

Specifically, as shown in FIG. 6, when six light emitting circuits are arranged in parallel, the number of parallel circuits energized by each pair of electrode terminals of the light emitting device 300 is four. However, in an arrangement with only individual light emitting circuits, the number of parallel circuits energized by each pair of electrode terminals is three. Thus, a larger current can flow through the light emitting device according to the present invention because of larger number of parallel circuits.

### Embodiment 4

As shown in FIG. 8, a light emitting device 400 according to the fourth embodiment of the present invention has anode electrode terminals 41 and 43 and cathode electrode terminals 42 and 44. The electrode terminals 41 and 42 are one set, and wirings 4A and 4C are connected in parallel in between. The electrode terminals 43 and 44 are another set, and wirings 4B and 4C are connected in parallel in between. Switching circuit units Q41 and Q42 are provided between connection points 412-417 and between connection points 415-417, that connect the wiring 4C and the electrode terminals. Each switching circuit portion adjusts the current to the wiring 4C according to the current difference between the two electrode terminals, and the emission color of the light emitting device 400 changes by the current ratio between the two electrode terminals.

The current difference between the two electrodes is detected by the comparator circuit unit 405 which is a comparison detection circuit by the voltage on the wiring and the like, and control signals are given to the switching circuit units Q41 and Q42. The configuration of the comparator circuit unit 405 may be only a comparator or a combination of a comparator and other electronic components. Further, a microcomputer may be used, and various signals to the switching circuit unit can be obtained by arithmetic processing.

The switching circuit units Q41 and Q42 may be only switching elements such as transistors, field effect transistors or thyristors, or may be a combination of switching elements and other electronic components. Further, not only the on-off control but also the amount of a current may be controlled to achieve a more desirable color change of the light emitting device.

As long as the amount of the current flowing between the respective electrode terminals can be detectable, the connection points 411 and 414 at which the comparator circuit unit 405 detects the voltage may be arranged at any point on the wirings, or may be arranged other than the light emitting device such as a power supply. Also, the wiring 4C may be individually constituted for each set of electrode terminals.

In the light emitting device 400, if the switching circuit is designed to turn on when a current flowing between the electrode terminals is larger, a current per LED package is leveled. Or, if the switching circuit is designed to turn on when a current flowing between the electrode terminals is smaller, a wider toning range can be obtained. By appropriately selecting the emission color of the LED packages on each wiring according to the condition that each switching circuit is turned on, a desired light output and emission color change of the light emitting device 400 can be obtained according to the current ratio between the electrode terminals 41, 42 and 43 , 44.

The present invention is not limited to the embodiments described above, and various modifications are possible within the scope of the claims, embodiments obtained by appropriately combining technical means disclosed in different embodiments also included in the technical scope of the present invention.

### EXAMPLE 1

In Example 1, the test was performed using the light emitting device having the same configuration as that of the first embodiment. The chromaticity point of the emission color of the wiring 1A was (0.4907, 0.4261), the chromaticity point of the emission color of the wiring 1B was (0.3818, 0.4053), and the chromaticity point of the emission color of the wiring 1C was (0.4686, 0.4053). The LED packages Lc1 and Lc2 on the wiring 1C were same emission color, and the emission color of the wiring 1C was made to be the same when energization between respective electrode terminals.

The chromaticity point of the emission color of the light emitting device was (0.4791, 0.4123) when only between the electrode terminals 11 and 12 was energized. And the chromaticity point of the emission color of the light emitting device was (0.4258, 0.4027) when only between the electrode terminals 13 and 14 was energized.

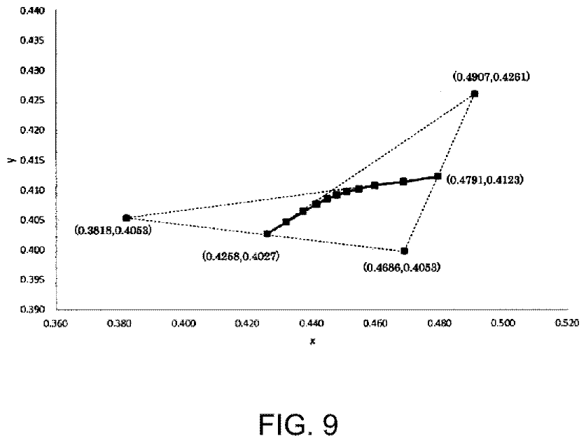

By changing the current ratio while keeping the sum of the current flowing between the electrode terminals 11, 12 and 13, 14 constant, the chromaticity point of the emission color of the light emitting device drew curve of the upward direction on the xy chromaticity diagram as shown in FIG. 9. Further, similar emission color and its change was obtained even at different sum of the current flowing between two sets of the electrode terminals.

### DESCRIPTION OF SYMBOLS

100, 200, 300, 400 Light emitting device. 301 Substrate. 11, 12, 13, 14, 21, 22, 23, 24, 31, 32, 32, 33, 34, 42, 43, 44 Electrode terminal. L1a 1-L1c 4, L2a 1-L2d 3, L4a 1-L4c 3 LED Package. D2a, D2b, D2cd Diode. E30 LED Element. 405 Comparator Circuit. Q41, Q42 Switching Circuit.

1. A light emitting device comprising:
a plurality of light emitting circuits connected in parallel between a first set of electrode terminals and a second set of electrode terminals, wherein,
each of the light emitting circuits includes a light emitting portion having a semiconductor light emitting element,
a first circuit of the light emitting circuits is an individual light emitting circuit through which a current flows only if the first set of the electrode terminals is energized,
a second circuit of the light emitting circuits between the respective set of the electrode terminals is a shared light emitting circuit having a common wiring section through which a current flows if either of the first set or the second set of the electrode terminals is energized, and
an emission color of the light emitting circuits by energization between the first set of the electrode terminals and an emission color of the light emitting circuits by energization between the second set of the electrode terminals are different from each other.

2. The device of claim 1, wherein an emission color of the first circuit and an emission color of the second circuit are different in each set of the electrode terminals.

3. The device of claim 2, wherein,
a chromaticity point of the emission color of the first circuit exists in a positive region,
a chromaticity point of the emission color of the second circuit exists in a negative region, wherein the regions are with respect to a straight line connecting the chromaticity point of the emission color of the first circuit and the chromaticity point of the emission color of the second circuit.

4. The device of claim 2, wherein,
the chromaticity point of the emission color of the first circuit exists in a positive region with respect to a black body radiation locus, and
a chromaticity point of the emission color of the second circuit exists in a negative region with respect to the black body radiation locus.

5. The device of claim 1, wherein the common wiring section includes the light emitting portion having the semiconductor light emitting element.

6. The device of claim 1, further comprising:
a diode between each set of the electrode terminals and the common wiring section.

7. The device of claim 1, wherein the semiconductor light emitting element between each set of the electrode terminals and the common wiring section forms a lighting unit.

8. The device of claim 1, further comprising:
a switch between each of the electrode terminals and the common wiring section; and
a comparison detection circuit measuring electrical differences between the first and the second sets of the electrode terminals and controlling the switch based on the measurement.

9. The device of claim 1, further comprising:
a shunt connected to the first set of the electrode terminals and the second set of the electrode terminals, wherein the shunt divides an input current from a single power source to the first and second set of electrode terminals.
